(19) United States
(12) Patent Application Publication
(10) Pub. No.: US 2009/0031964 A1
(43) Pub. Date: Feb. 5, 2009

(54) Combined furniture and animal housing

(76) Inventor: Barbara Kelley Proxmire, Bethesda, MD (US)

Correspondence Address: PATTON BOGGS LLP, 8484 WESTPARK DRIVE, SUITE 900, MCLEAN, VA, 22102, US

(21) Appl. No.: 11/905,222

(22) Filed: Sep. 28, 2007

Related U.S. Application Data
(60) Provisional application No. 60/935,214, filed on Aug. 1, 2007.

(51) Int. Cl. A01K 1/035; A47B 88/04; B65D 25/04

(52) U.S. Cl. 119/484; 220/919; 312/334.1

(57) ABSTRACT

A combination article of furniture and housing for an animal is provided. Openings may be covered with multiple breathable layers to allow airflow and visibility into and out of a recess in the article of furniture. A slidable tray may be disposed within the recess. The slidable tray may slide in and out of the recess on a track A standard pet crate or a set of removable slides or dividers may allow customization of the interior volume of the recess. The removable slides or dividers may be secured within the housing by grooves.

### CROSS REFERENCE TO RELATED APPLICATIONS

The present application claims priority to U.S. Provisional Patent Application Ser. No. 60/935,214, filed Aug. 1, 2007, which is hereby incorporated by reference in its entirety.

### FIELD OF THE INVENTION

The invention relates generally to an apparatus and methods for housing animals, and, more particularly, to apparatus and methods for providing enclosures for pets that also serve as functional furniture for pet owners.

### BACKGROUND OF THE INVENTION

Current pet housing, such as dog crates and other similar types of cages, may take up a large amount of space in a pet owner's home. Furthermore, current pet housing is often not aesthetically pleasing. Functionality would be increased if a piece of standard furniture in a home could also be used to house a pet.

Many different types of pet cages have been utilized to house pet animals, from portable pet carriers to wire metal cages. Such cages generally include an enclosure large enough to contain the animal and a lockable or latched cage door to prevent the animal from entering and leaving the cage at will. While such pets as dogs and cats are often given free run of the house, it may be desirable to temporarily house the family pet in a cage, e.g., when guests are invited over or when the owner will be absent from home.

Furthermore, dogs and other pets may be natural den animals. These types of pets may be more comfortable in a small space. Often, when a cage or crate is left open, pets may choose to sleep inside a cage or crate rather than out in an open room. A cage or crate may function as an artificial den, i.e., a small, personal, cozy place where pets may feel safe and secure. Pets may prefer a small enclosure that acts as a place to retire to avoid external stressors.

Cages and other pet enclosures, however, are typically utilitarian in design and are immediately identifiable as cages and pet housings. Such obtrusive and obvious animal enclosures often clash with the furniture and decor found in the pet owner's home.

Although pet enclosures having the external appearance of ordinary household furniture have been proposed before, such pet enclosures typically include some sort of cabinet having conventional cabinet doors and construction. To confine the pet within the cabinet, the cabinet doors are closed, thus locking the pet inside a dark chamber with little airflow. While such enclosures are effective in confining the animal, the enclosures often deprive the pet of light, or deprive the pet of adequate ventilation, even when a fan is provided. Furthermore, such enclosures do not allow for visibility into the enclosure by the pet owner or out of the enclosure by the pet.

Other existing systems require the use of complex and/or unwieldy removable panels or sides to secure an animal within the furniture. Other existing systems merely provide a receptacle for standard pet cages or crates within a piece of furniture. Many existing systems do not provide for any adjustment of the internal volume of a given pet enclosure. Other existing systems merely provide dividers within an internal volume.

For these and other reasons, no enclosure for pets that blends in with the furniture and decor of the home has proven entirely satisfactory. Thus, furniture containing a cage for a pet animal solving the aforementioned problems is desired. Generally, needs exist for improved apparatus and methods for housing animals that is also functional as furniture and aesthetically pleasing.

### SUMMARY OF THE INVENTION

Embodiments of the present invention solve many of the problems and/or overcome many of the drawbacks and disadvantages of the prior art by providing an apparatus and methods for housing animals within furniture.

In particular, embodiments of the invention may accomplish by providing a combination pet housing and article of furniture including an enclosure for housing a pet with one or more sides, one or more openings within the enclosure, a first breathable layer covering at least one of the one or more openings, a second breathable layer covering the first breathable layer, and a passage into the enclosure for a pet to enter and leave the enclosure.

In embodiments of the present invention the first breathable layer may be a mesh and the second breathable layer may be a decorative lattice. The first breathable layer and the second breathable layer may be proximate to one another.

A door may cover the passage. The door may recess into the enclosure in the open position. The door may be a drop leaf panel, a hinged door, a pocket door, or any other suitable closure.

In embodiments of the present invention at least one of the one or more sides of the enclosure may be drop leaf panels. A vertically adjustable top surface of the enclosure may be provided. A removable top surface of the enclosure may cover the passage.

The enclosure may accept a pet crate, pet bed or litter box.

Embodiments of the present invention may include odor removers.

One or more removable walls may be provided within the enclosure and one or more slots corresponding to the one or more removable walls for securing the one or more removable walls within the enclosure at a desired location.

One or more slides may be provided within the enclosure and a slidable base within the enclosure coupled to the one or more slides wherein the slidable base moves at least partially into and out of the enclosure coupled to the one or more slides.

Embodiments of the present invention may also be a combination pet housing and article of furniture including an enclosure for housing a pet with one or more side walls, one or more removable walls within the enclosure, one or more slots corresponding to the one or more removable walls for securing the one or more removable walls within the enclosure at a desired location, and a passage into the enclosure for a pet to enter and leave the enclosure.

A top panel may be removably coupled to the one or more removable walls. The one or more removable walls may be breathable.

In embodiments of the present invention one or more openings may be provided within the enclosure, a first breathable layer may cover at least one of the one or more openings, and a second breathable layer may cover the first breathable layer.

Embodiments of the present invention may also be a combination pet housing and article of furniture including an article of furniture, a recess within the article of furniture for housing a pet, one or more openings within the article of furniture, a first breathable layer covering at least one of the one or more openings, a second breathable layer covering the first breathable layer, one or more removable walls within the recess, one or more slots corresponding to the one or more removable walls for securing the one or more removable walls within the recess at a desired location, one or more slides within the recess, a slidable base within the recess coupled to the one or more slides wherein the slidable base moves at least partially into and out of the recess coupled to the one or more slides, and an opening within the article of furniture for the pet to access the recess.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE INVENTION

The accompanying drawings, which are included to provide a further understanding of the invention and are incorporated in and constitute a part of this specification, illustrate preferred embodiments of the invention and together with the detailed description serve to explain the principles of the invention. In the drawings:

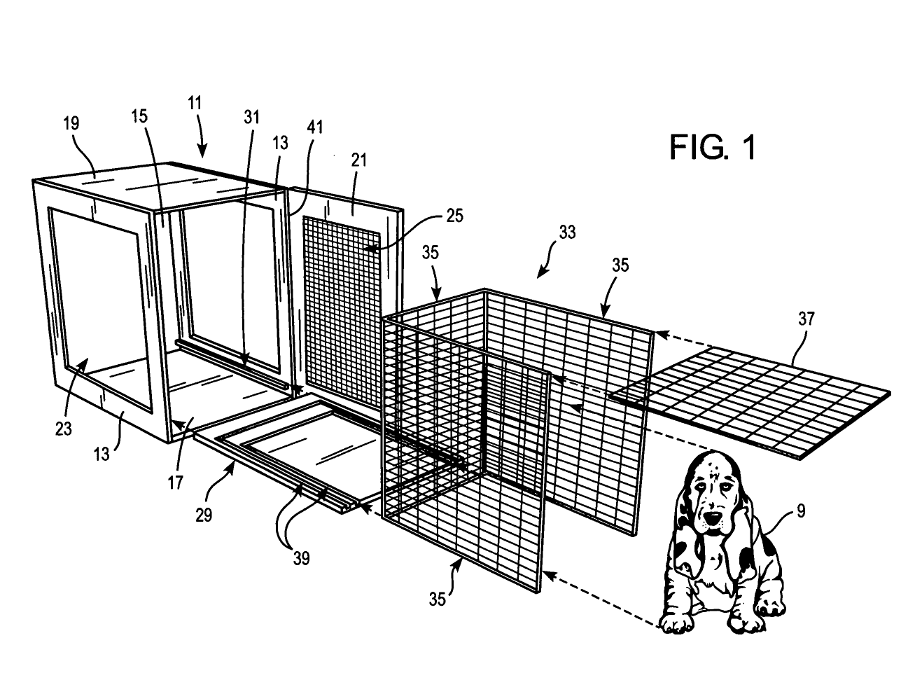

FIG. 1 is an exploded view of a housing.

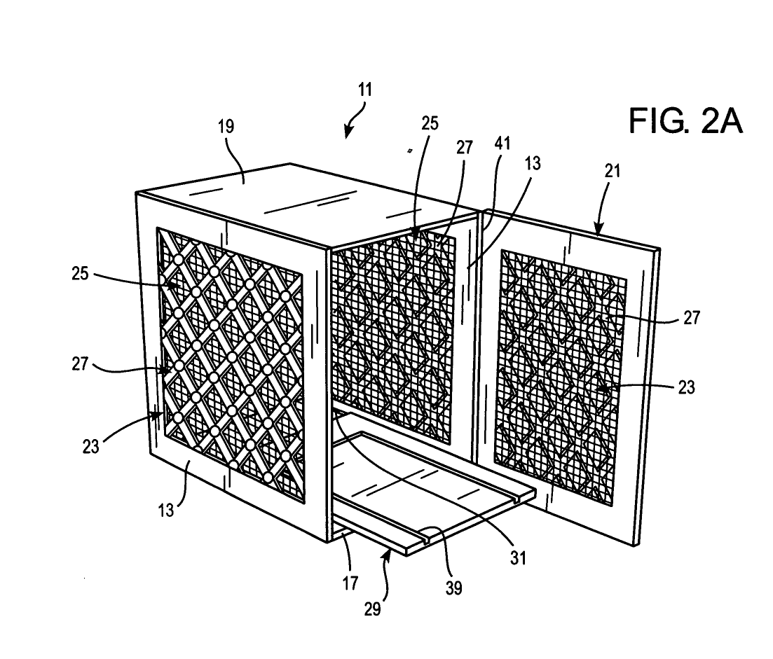

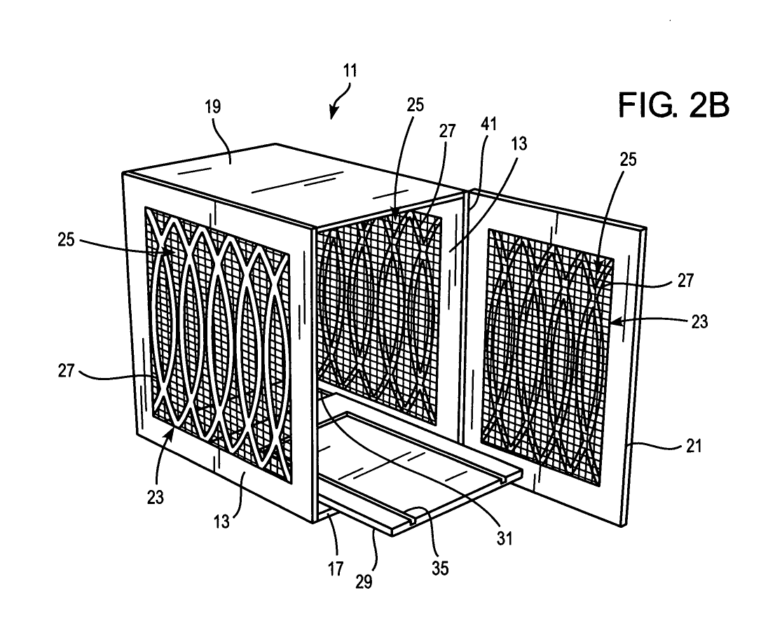

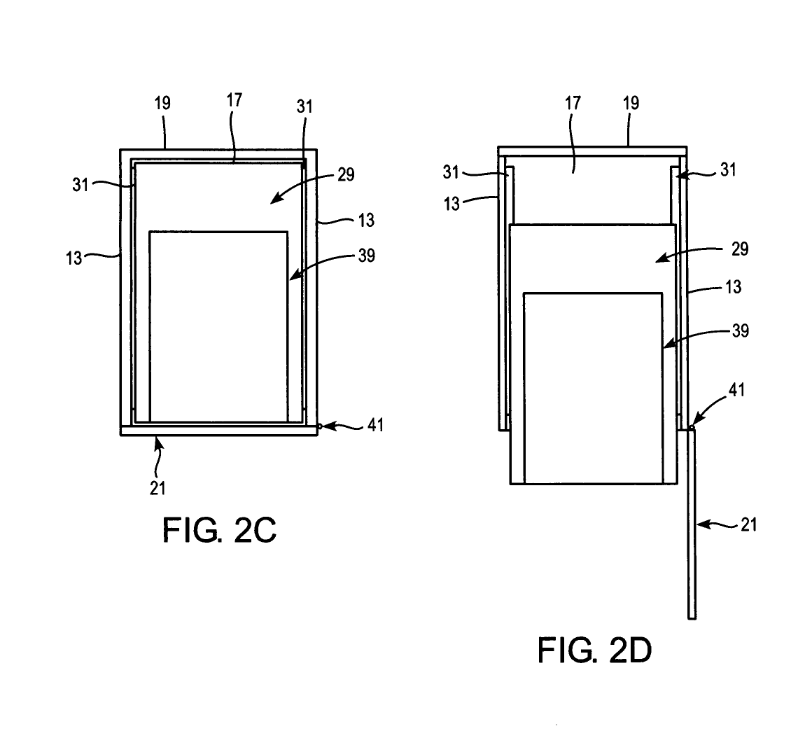

FIG. 2A is a perspective view of a housing with a double breathable layer and a slidable tray.

FIG. 2B is a perspective view of the housing of FIG. 2A with an alternative breathable layer.

FIG. 2C is a plan view of the housing of FIG. 2A with a closed door.

FIG. 2D is a plan view of the housing of FIG. 2A with an open door and a partially extended slidable tray.

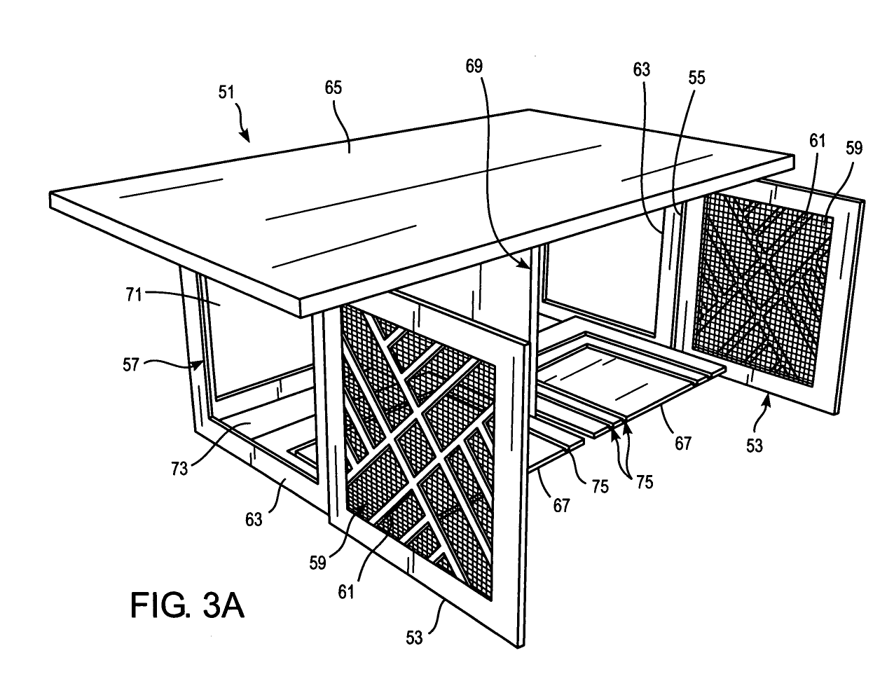

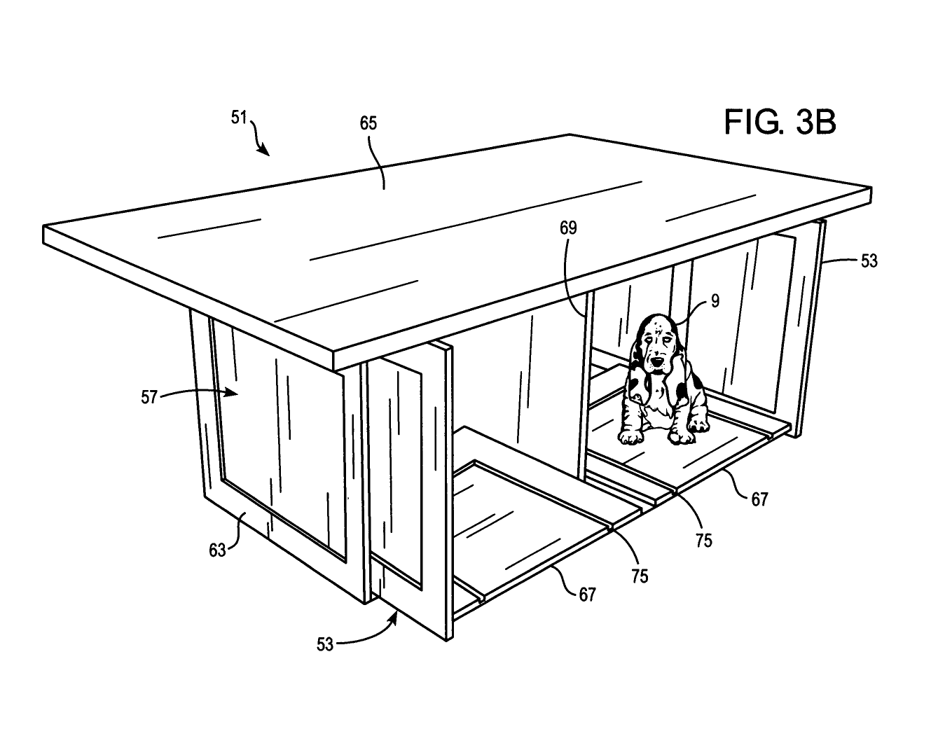

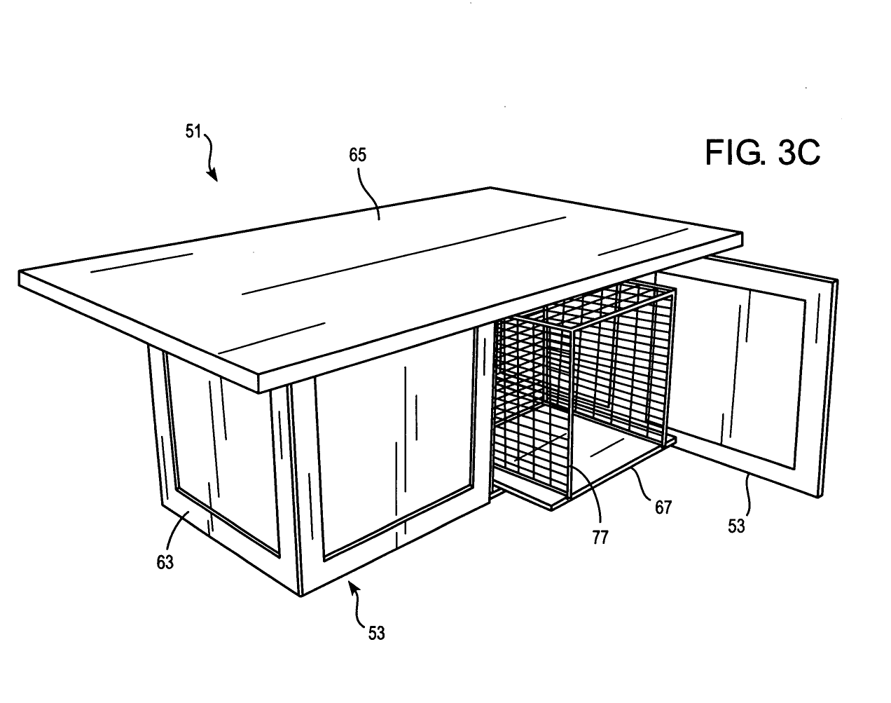

FIG. 3A is a perspective view of a housing with double doors.

FIG. 3B is perspective view of an alternative housing with double doors.

FIG. 3C is a perspective view of the housing of FIG. 3A with a removable cage.

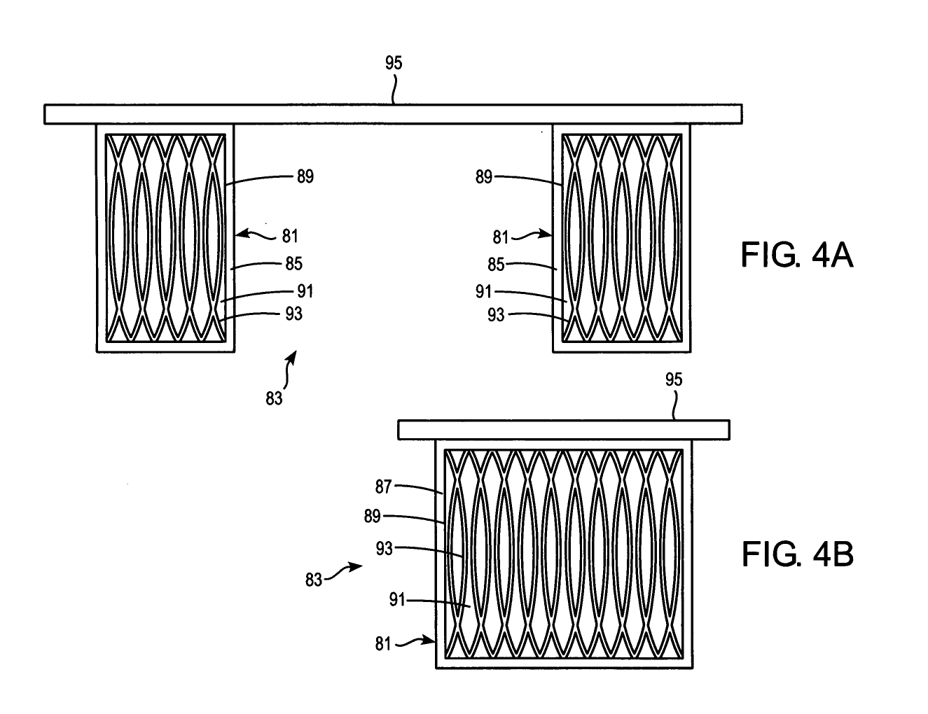

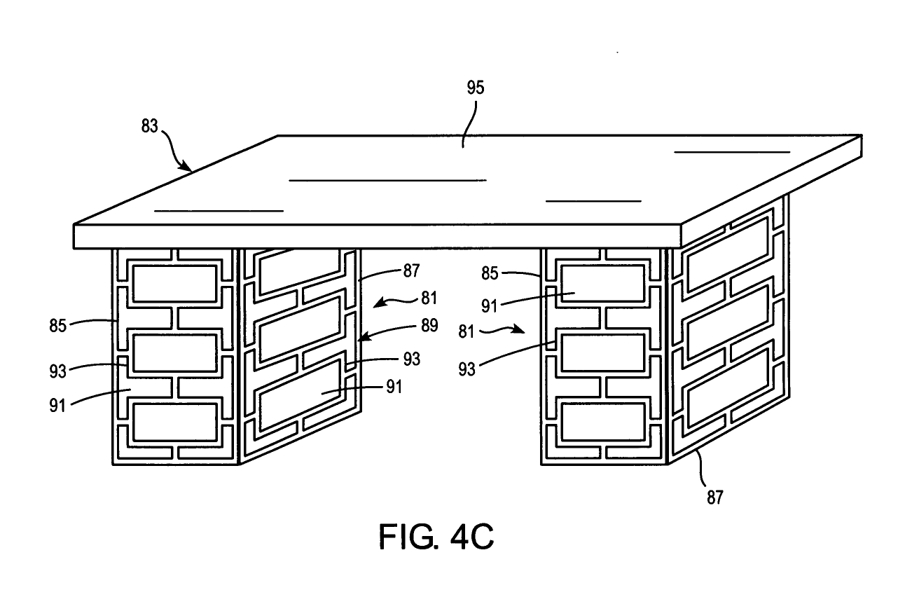

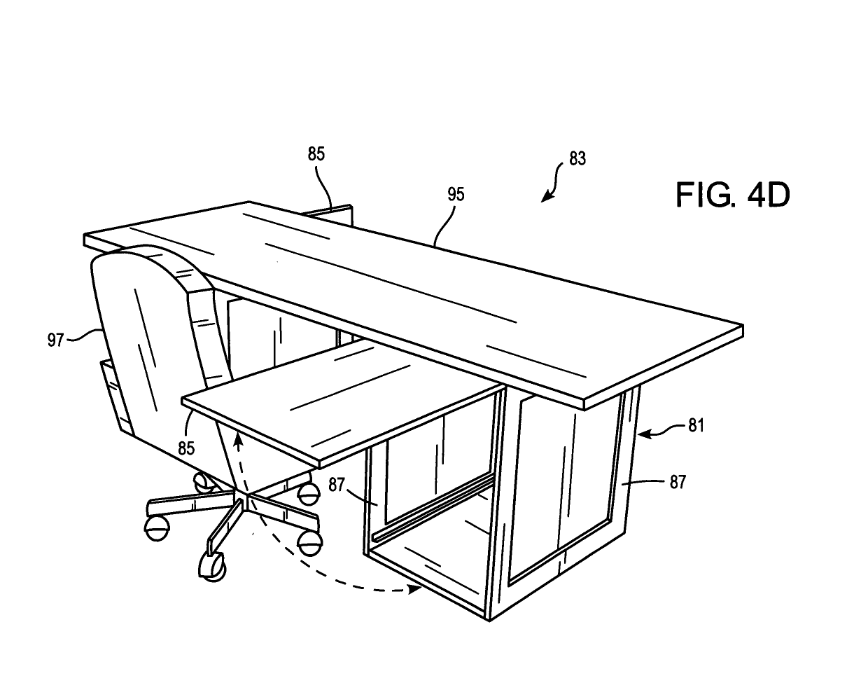

FIG. 4A is a front elevation of a housing with two separate compartments.

FIG. 4B is a side elevation of the housing of FIG. 4A

FIG. 4C is a perspective view of the housing of FIG. 4A with an alternative breathable layer.

FIG. 4D is a perspective view of the housing of FIG. 4A with a drop leaf.

FIG. 5 is a perspective view of a cubby with a side door.

FIG. 6 is a perspective view of a bench.

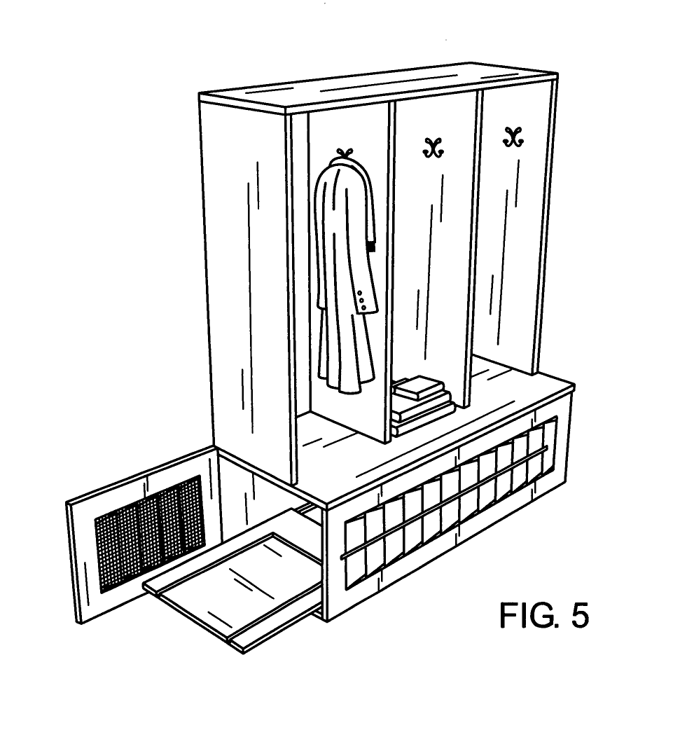

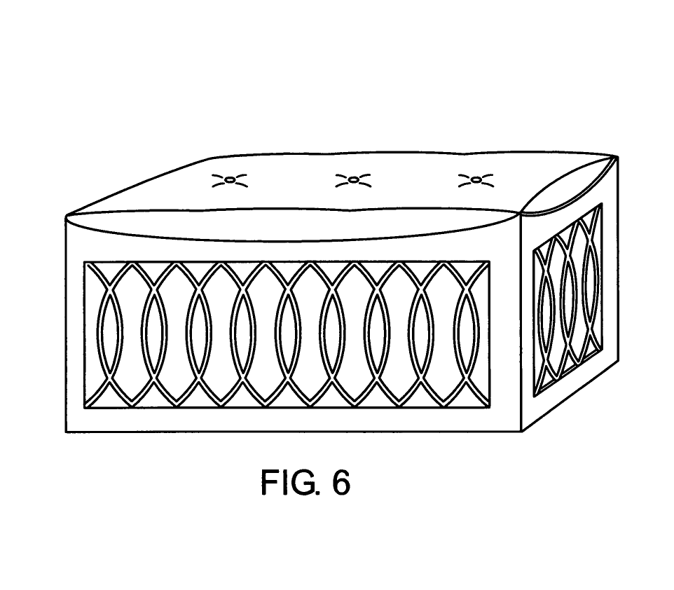

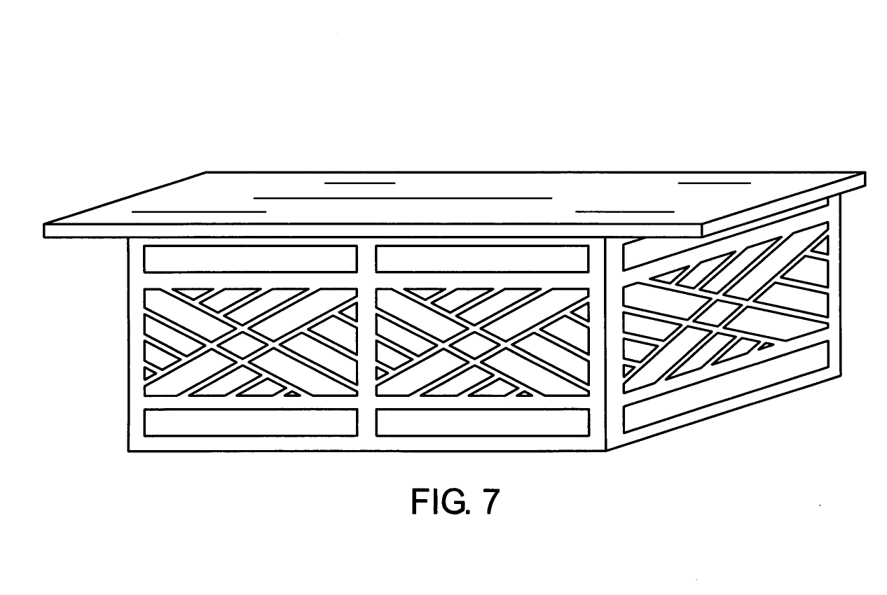

FIG. 7 is a perspective view of a table.

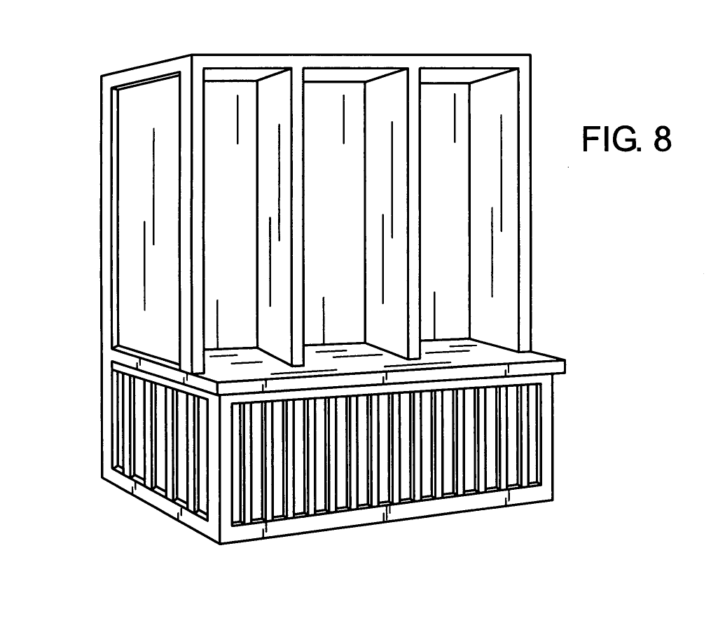

FIG. 8 is a perspective view of a cubby.

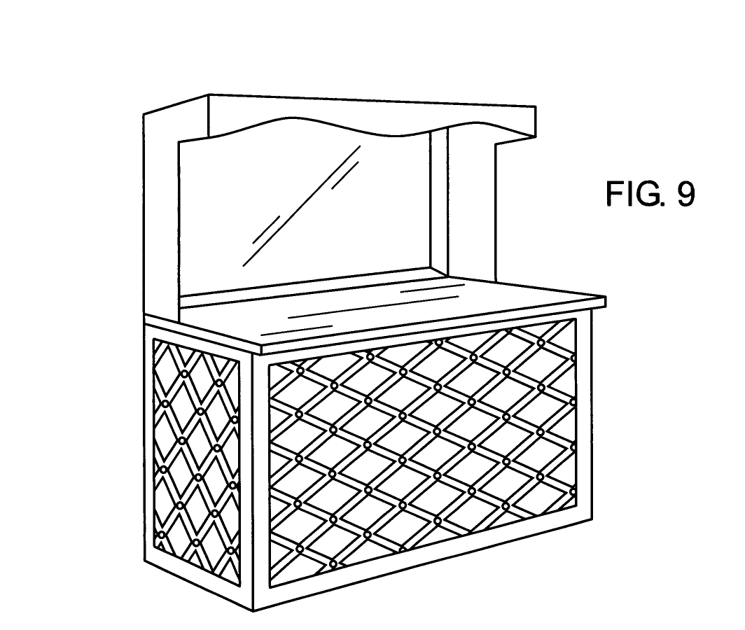

FIG. 9 is a perspective view of a banquette.

### DETAILED DESCRIPTION OF THE PREFERRED EMBODIMENTS

Embodiments of the present invention may include apparatus and methods for housing animals within functional furniture. Embodiments of the present invention may include pet housings that look and/or function as a standard piece of furniture.

FIGS. 1-2 show a housing 11. The housing 11 may be any dimension or shape to correspond to a functionality desired in a standard piece of furniture. The housing 11 may also have dimensions or shapes to fit particular types and sizes of animals 9. FIG. 1 shows a roughly cubic housing 11. Other shapes and configurations are possible depending on the desired uses. The housing 11 may be formed from a combination of one or more wall panels 13, back panels 15, bottom panels 17, top panels 19 and/or door panels 21. The number and configuration of each of the panels may be varied depending on the particular use of an embodiment of the present invention.

Any of the panels, but preferably at least one wall panel 13, back panel 15 and/or a door panel 21 may each contain one or more openings 23. The openings 23 may allow for ventilation of an interior volume of the housing 11. Additionally, the openings 23 may allow an animal 9 within the housing 11 to see out of the housing 11 and animal owners to see into the housing 11. In embodiments of the present invention the openings 23 occupy a majority of each of the wall panels 13.

The openings 23 may be covered by one or more breathable layers. Embodiments of the present invention may include a first breathable layer 25 and a second breathable layer 27. The first breathable layer 25 may be proximate to the interior of the housing 11. The first breathable layer 25 may be a mesh, screen, membrane or other material that allows at least partial flow of air and light through the first breathable layer 25. The second breathable layer 27 may be proximate to the exterior of the housing 11. The second breathable layer 27 may be a mesh, screen, membrane or other material that allows at least partial flow of air and light through the second breathable layer 27. More preferably, the second breathable layer 27 may be decorative lattice work or another decorative covering in various configurations. The first breathable layer 25 and the second breathable layer 27 may abut one another or may be separated by a distance. Preferably, the first breathable layer 25 and the second breathable layer 27 are in close proximity to one another. The openings 23 may be sized and configured as needed for functionality and aesthetic purposes. The openings 23 may preferably be provided from all side panels 13, back panels 15 and door panels 21 of the housing 11. Preferably, no work is required to allow for ventilation through the openings 23. The first breathable panel 25 and the second breathable panel 27 are preferably constructed of materials that cannot readily be compromised by an animal within the housing 11.

The housing 11 and components of the housing 11 in general are preferably constructed of materials that are durable, resistant to chewing by the animals, non-toxic, waterproof, stain resistant, etc.

A slidable tray 29 may be disposed within the housing 11. Embodiments without a slidable tray 29 are contemplated. Without a slidable tray 29, an animal within the housing 11 may rest on a bottom panel 17 or if there is no bottom panel the animal 9 may rest directly on the surface that the housing 11 rests upon. Embodiments of the present invention may include a fixed tray. For purposes of this description, a slidable tray 29 is included. The slidable tray 29 may act as a floor within the housing 11. The slidable tray 29 may slide along a track 31 on bearings, wheels or other similar systems. The slidable tray 29 may have complementary hardware (not shown) corresponding to the track system 31. The slidable tray 29 may be partially or completely removed from an interior volume of the housing 11 by moving along the track 31. The material of the slidable tray 29 may be metal, plastic, wood or any other suitable material to facilitate clean up after the animal 9.

A removable inner cage 33 may be placed within the housing 11. A removable inner cage 33 may be desirable to reduce the inner volume of the housing 11. A reduced inner volume may create a more comfortable and safe living environment for a small or young animal. The inner cage 33 may include one or more side walls 35 and one or more top walls 37 depending on the size and configuration desired. Preferably, the inner cage 33 includes three side walls 35 and one top wall 37. The side walls 35 and top walls 37 may be made of any material, but preferably are constructed of materials that allow light and air to pass from the outside of the housing 11 into the inner cage 33. The side walls 35 and top walls 37 may be grids of metal, plastic, wood or other material.

The removable inner cage 33 may be adjustable to create various inner volumes. The one or more side walls 35 may be secured within grooves 39 in the slidable tray 29 or bottom panel 17 if there is no slidable tray 29. The grooves 39 may be sized to accept the one or more side walls 35. There may be a series of grooves 35 with various dimensions to accept side walls 35 of various dimensions. Sets of side walls 35 corresponding to each series of grooves 35 may be provided for a user to determine the desired inner volume of the inner cage 33.

One or more top walls 37 may be secured to the one or more side walls 35 to create a complete inner cage 33. The one or more top walls 37 may be pre-secured to the one or more side walls 35 or may be fastened to the one or more side walls 35 with clips, hook and loop fasteners, snaps, corresponding notches and grooves, or other suitable closures. The one or more top walls 37 may be secured to one or more than one of the side walls 35. The removable inner cage 33 may provide small or young animals with a smaller volume of living space within the housing. The removable inner cage 33 may be color coordinated to the exterior of the housing 11 to increase aesthetic appeal. Furthermore, the removable inner cage 33 may be pattered to complement a second breathable layer 27 and disguise the removable inner cage 33 when viewed from the exterior of the housing 11.

Alternatively, in place of the inner cage 33 a standard off-the-shelf pet crate, pet bed, litter box or other similar apparatus may be placed within the housing 11. A standard pet crate may reduce the inner volume of the housing 11 as described above for the inner cage 33 without requiring the removable inner cage 33. Embodiments of the present invention may accommodate various sized animals by creating customized spaces.

A door panel 21 may cover an entrance/exit to the housing 11. The door panel 21 may be connected to the housing 11 by a hinge 41 or any other suitable coupling. As described earlier, the door panel 21 may have an opening 23 covered by a first breathable layer 25 and a second breathable layer 27. The door panel 21 may be a hinged door, pocket door, drop leaf, garage-type door, or any other type of suitable closure. A hinged door may be hinged and then allow the door to recess within the housing 11 to increase space in a living area and hide the door panel 21 when not in use. A drop leaf door may rise up along a hinge and be secured in an open position. Alternatively, the drop leaf door may recess within the housing to increase space in a living area and hide the door panel 21 when not in use. A garage-type door may roll, fold or compress into the housing in a manner similar to existing garage doors for houses. The garage-type door may allow for more useful space in small rooms.

As an alternative to door panels 21, the top panel 19 may lift up to allow access to the interior volume of the housing 11. The top panel 19 may lift off completely, rotate around a hinge or otherwise lift off the side panels 13. A user may place or remove an animal from the interior of the housing 11 through the open top of the housing 11 instead of allowing the animal to use a door panel 19.

FIGS. 2A and 2B show alternative second breathable layers 27. The second breathable layers 27 may be made of wood, plastic, metal, lattice, cane or any other suitable materials. The second breathable layers 27 may mimic the form and configuration of an inner cage 33 or standard animal crate to disguise the contents of the housing 11 as much as possible.

FIGS. 2C and 2D show the slidable tray 29 in a recessed and extended position, respectively. The slidable tray 29 may be removed from the housing 11 to various degrees depending on the configuration and desired use.

FIGS. 3A-3C show a housing 51 with multiple doors 53. The one or more doors 53 may swing out around hinges 55. The one or more doors 53 may swing out and then tuck back into the housing 51 for providing better access to the housing 51 and increasing available space within a room. FIG. 3B shows the doors 53 partially recessed into the housing 51. The one or more doors 53 may have openings 57 covered by a first breathable layer 59 and a second breathable layer 61 as described above in reference to FIGS. 1-2. For purposes of illustration, the first breathable layer 59 and the second breathable layer 61 have been left off side panels 63 in FIG. 3A. FIGS. 3A-3C show a table configuration for the housing 51. A table top 65 may act as a top panel for the housing 51. The housing 51 may also have one or more back panels 71 and bottom panels 73.

One or more slidable trays 67 may be disposed within the housing 51. An interior volume of the housing 51 may be divided into two or more regions with one or more dividers 69. The one or more dividers may allow for multiple animals and/or storage within the housing 51. The one or more slidable trays 67 may slide into and out of the housing 51 on tracks (not shown) or other similar devices as described above for FIGS. 1-2. The one or more slidable trays 67 may have one or more sets of grooves 75 for holding a removable cage 77 similar to that found in FIGS. 1-2 and shown in FIG. 3C.

FIG. 4A-4D show multiple housings areas 81 within an article of furniture 83. The housing areas 81 may be separate compartments for housing multiple animals or housing animals and storing materials. An opening for an animal may be covered by a door panel 85. The door 85 may be a hinged door, drop leaf, garage-type door, or any other type of suitable closure as described above. The housing may have doors 85 and/or side panels 87 with openings 89 covered by a first breathable layer 91 and a second breathable layer 93 as described above in reference to FIGS. 1-2. FIGS. 4A-4D show a desk embodiment with a desktop 95. FIG. 4C shows an alternative configuration of the second breathable layer 93 on the furniture 83. FIG. 4D shows a drop leaf door 85 that may provide additional work space for a user sitting in a chair 97. One or more panels may act as doors 85 such that the animal may enter from various sides of the housing 81.

FIGS. 5-9 show alternative pieces of furniture that may house an animal in a manner similar to those embodiments described above. Furniture that may be used includes, but is not limited to, banquettes, end tables, dining tables, benches, cubbies, baker's racks, coffee tables, etc.

Embodiments of the present invention may allow for multiple configuration or uses of a single article of furniture.

Embodiments of the present invention may include odor removers. Odor removers may be attached within the recess. Preferably, the odor removers are placed out of reach of the animal. The odor removers may be attached using adhesive, hook and loop fasteners or any other coupling devices. If a removable cage or off-the-shelf pet crate is used within the interior volume of the housing, the odor remover may be placed within the interior volume, but outside the removable cage or off-the-shelf pet crate.

Embodiments of the present invention may include locks or other devices for securing the opening in the housing to prevent the animal from entering or leaving the housing.

Embodiments of the present invention may also include a top that may be raised to alter the height of a top surface of the housing. This may be particularly useful for embodiments used as tables. The raising top may increase functionality as an article of furniture while providing an appropriately sized housing for an animal.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A combination pet housing and article of furniture comprising:
an enclosure for housing a pet with one or more sides,
one or more openings within the enclosure,
a first breathable layer covering at least one of the one or more openings,
a second breathable layer covering the first breathable layer, and
a passage into the enclosure for a pet to enter and leave the enclosure.

2. The apparatus of claim 1, wherein the first breathable layer is a mesh.

3. The apparatus of claim 1, wherein the second breathable layer is a decorative lattice.

4. The apparatus of claim 1, wherein the first breathable layer and the second breathable layer are proximate to one another.

5. The apparatus of claim 1, further comprising a door covering the passage.

6. The apparatus of claim 5, wherein the door recesses into the enclosure in the open position.

7. The apparatus of claim 5, wherein the door is a drop leaf panel.

8. The apparatus of claim 1, wherein the at least one of the one or more sides of the enclosure are drop leaf panels.

9. The apparatus of claim 1, further comprising a vertically adjustable top surface of the enclosure.

10. The apparatus of claim 1, further comprising a removable top surface of the enclosure covering the passage.

11. The apparatus of claim 1, wherein the enclosure accepts a pet crate, pet bed or litter box.

12. The apparatus of claim 1, further comprising odor removers.

13. The apparatus of claim 1, further comprising one or more removable walls within the enclosure and one or more slots corresponding to the one or more removable walls for securing the one or more removable walls within the enclosure at a desired location.

14. The apparatus of claim 1, further comprising one or more slides within the enclosure and a slidable base within the enclosure coupled to the one or more slides wherein the slidable base moves at least partially into and out of the enclosure coupled to the one or more slides.

15. A combination pet housing and article of furniture comprising:
an enclosure for housing a pet with one or more side walls,
one or more removable walls within the enclosure,
one or more slots corresponding to the one or more removable walls for securing the one or more removable walls within the enclosure at a desired location, and
a passage into the enclosure for a pet to enter and leave the enclosure.

16. The apparatus of claim 15, further comprising a top panel removably coupled to the one or more removable walls.

17. The apparatus of claim 15, wherein the one or more removable walls are breathable.

18. The apparatus of claim 15, further comprising one or more openings within the enclosure, a first breathable layer covering at least one of the one or more openings, and a second breathable layer covering the first breathable layer.

19. The apparatus of claim 15, further comprising one or more slides within the enclosure and a slidable base within the enclosure coupled to the one or more slides wherein the slidable base moves at least partially into and out of the enclosure coupled to the one or more slides.

20. A combination pet housing and article of furniture comprising:
an article of furniture,
a recess within the article of furniture for housing a pet,
one or more openings within the article of furniture,
a first breathable layer covering at least one of the one or more openings,
a second breathable layer covering the first breathable layer,
one or more removable walls within the recess,
one or more slots corresponding to the one or more removable walls for securing the one or more removable walls within the recess at a desired location,
one or more slides within the recess,
a slidable base within the recess coupled to the one or more slides wherein the slidable base moves at least partially into and out of the recess coupled to the one or more slides, and
an opening within the article of furniture for the pet to access the recess.
